(19) United States
(12) Patent Application Publication
(10) Pub. No.: US 2024/0212031 A1
(43) Pub. Date: Jun. 27, 2024

(54) INFORMATION FLOW ADVERTISEMENT-BASED INTERACTION METHOD AND APPARATUS, DEVICE, AND MEDIUM

(71) Applicant: Tencent Technology (Shenzhen) Company Limited, Shenzhen (CN)

(72) Inventor: Yilang XU, Shenzhen (CN)

(21) Appl. No.: 18/600,477

(22) Filed: Mar. 8, 2024

Related U.S. Application Data
(63) Continuation of application No. PCT/CN23/83181, filed on Mar. 22, 2023.

(30) Foreign Application Priority Data
Jun. 16, 2022 (CN) 202210687102.X

(51) Int. Cl. G06Q 30/0601; G06F 3/04817; G06Q 30/0241; G06T 3/40; G06T 3/60

(52) U.S. Cl. CPC G06Q 30/0641; G06F 3/04817; G06Q 30/0277; G06Q 30/0631; G06T 3/40; G06T 3/60

(57) ABSTRACT

This application discloses an information flow advertisement-based interaction method and apparatus, a device, and a medium, and belongs to the field of human-computer interaction. The method includes: displaying an information flow interface of a first user account, the information flow interface including social content transmitted by at least one content publishing account (210); displaying, on the information flow interface, an information flow advertisement including a first display object (220); displaying, in response to receiving a first interaction operation, a real-scene interaction interface of a second display object associated with the first display object (230); and displaying, in response to receiving a second interaction operation, scene pictures of the second display object corresponding to different observation manners on the real-scene interaction interface, the scene pictures including recommended objects (240). According to the above solution, a click-through rate of the information flow advertisement is increased.

### CROSS-REFERENCE TO RELATED APPLICATIONS

This application is a continuation application of PCT Patent Application No. PCT/CN2023/083181, entitled “INFORMATION FLOW ADVERTISEMENT-BASED INTERACTION METHOD AND APPARATUS, DEVICE, AND MEDIUM” filed on Mar. 22, 2023, which claims priority to Chinese Patent Application No. 202210687102.X, entitled “INFORMATION FLOW ADVERTISEMENT-BASED INTERACTION METHOD AND APPARATUS, DEVICE, AND MEDIUM” filed on Jun. 16, 2022, all of which is incorporated by reference in its entirety.

### FIELD OF THE TECHNOLOGY

Embodiments of this application relate to the field of human-computer interaction, and in particular, to an information flow advertisement-based interaction method and apparatus, a device, and a medium.

### BACKGROUND OF THE DISCLOSURE

Nowadays, advertising on an information flow interface is common. For example, information flow advertisements delivered by advertising accounts and social content transmitted by content publishing accounts are distributed on the information flow interface.

In the related art, in an information flow advertisement, a recommended commodity is briefly introduced by using multimedia materials such as text, a picture, and a video, a user account enters a virtual store by clicking on the multimedia materials, and the recommended commodity is introduced again in detail in the virtual store through the text, the picture, and the video.

In the related art, the information flow advertisement interacts with the user account in a relatively simple manner, leading to a low click-through rate of the information flow advertisement.

### SUMMARY

This application provides an information flow advertisement-based interaction method and apparatus, a device, and a medium to increase a click-through rate of an information flow advertisement. The technical solutions are as follows:

According to an aspect of this application, an information flow advertisement-based interaction method is performed by a computer device, the method including:

displaying an information flow interface of a first user account, the information flow interface including social content transmitted by at least one content publishing account;

displaying, on the information flow interface, an information flow advertisement including a first display object;

in response to receiving a first interaction operation on the first display object, displaying a real-scene interaction interface of a second display object associated with the first display object, wherein the second display object represents a physical building; and

in response to receiving a second interaction operation on the second display object, displaying scene pictures of the second display object corresponding to different observation manners on the real-scene interaction interface, the scene pictures comprising recommended objects located in the physical building.

According to an aspect of this application, a computer device is provided, the computer device including a processor and a memory, the memory storing a computer program, and the computer program being loaded and executed by the processor and causing the computer device to perform the information flow advertisement-based interaction method as described above.

According to another aspect of this application, a non-transitory computer-readable storage medium is provided, storing a computer program, the computer program being loaded and executed by a processor of a computer device and causing the computer device to implement the information flow advertisement-based interaction method as described above.

The technical solutions provided in the embodiments of this application bring at least the following beneficial effects: displaying the first display object on the information flow advertisement, displaying, in response to the first interaction operation, the real-scene interaction interface of the second display object, and displaying, in response to the second interaction operation, the scene pictures of the second display object corresponding to the different observation manners. According to the above solutions, types of human-computer interaction are enriched, thereby increasing a frequency of interaction between a user account and the information flow advertisement and increasing a click-through rate of the information flow advertisement.

### BRIEF DESCRIPTION OF THE DRAWINGS

FIG. 1 is a structural block diagram of a computer system according to an exemplary embodiment of this application.

FIG. 2 is a flowchart of an information flow advertisement-based interaction method according to an exemplary embodiment of this application.

FIG. 3 is a schematic diagram of an interface changing process according to an exemplary embodiment of this application.

FIG. 4 is a schematic diagram of a real-scene interaction interface according to an exemplary embodiment of this application.

FIG. 5 is a schematic diagram of a real-scene interaction interface according to another exemplary embodiment of this application.

FIG. 6 is a schematic diagram of a real-scene interaction interface according to another exemplary embodiment of this application.

FIG. 7 is a schematic diagram of a real-scene interaction interface according to another exemplary embodiment of this application.

FIG. 8 is a schematic diagram of an information flow interface according to an exemplary embodiment of this application.

FIG. 9 is a flowchart of an information flow advertisement-based interaction method according to another exemplary embodiment of this application.

FIG. 10 is a structural block diagram of an information flow advertisement-based interaction apparatus according to an exemplary embodiment of this application.

FIG. 11 is a structural block diagram of a computer device according to an exemplary embodiment of this application.

### DESCRIPTION OF EMBODIMENTS

First, the terms involved in the embodiments of this application are briefly introduced. An information flow (a feed stream) refers to a data form that is continuously updated and presents content to a user. The information flow includes at least a timeline-based presentation manner and a random presentation manner. The timeline-based presentation manner means displaying content to the user in a chronological order in which content of the information flow is updated. The random presentation manner means calculating a weight of the content according to certain factors to determine an order in which the content is displayed. For example, a social interaction platform calculates a weight of content published by a subscription according to an algorithm, and determines, according to the weight, an order in which the content published by the subscription is recommended to the user. The information flow also displays the content in different manifestation forms. Common manifestation forms are, for example, list, cascade, and card forms. The information flow may alternatively be considered as aggregation of at least one resource provided by at least one content source that a user account subscribes to.

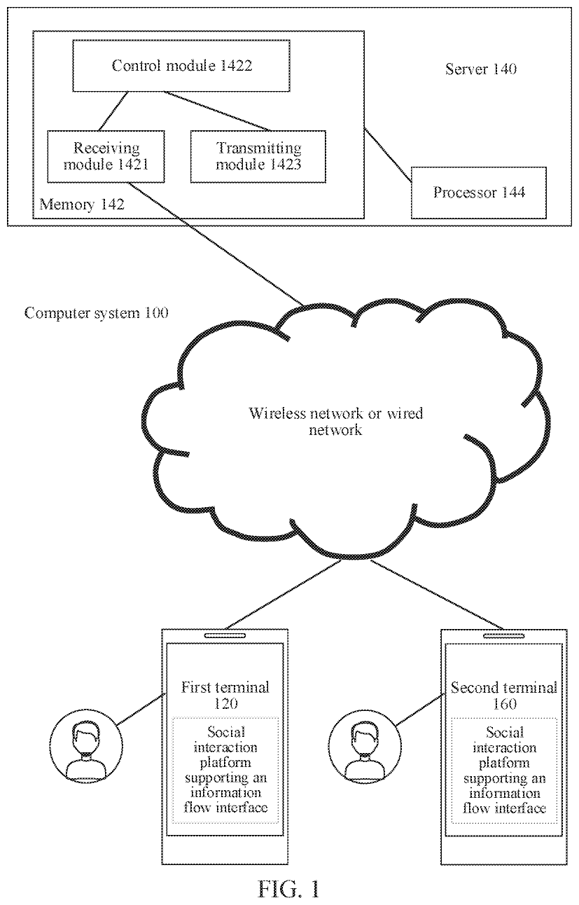

FIG. 1 is a structural block diagram of a computer system according to an exemplary embodiment of this application. The computer system 100 includes a first terminal 120, a server 140, and a second terminal 160. A social interaction platform supporting an information flow interface is installed and run on the first terminal 120. A first user account is logged in to a first social interaction platform. The first user account may browse or publish content on the information flow interface of the social interaction platform. The first user account may further interact, through the information flow interface displayed on the social interaction platform, with an account that the first user account subscribes to. For example, the social interaction platform is a friend circle of a social program, and the first user account may give a like to and comment on social content published by a friend account thereof. For example, the first social interaction platform is a question-and-answer community, and the first user account may agree, comment on, share, report, and ignore content published by a user account that the first user account follows. A social interaction platform supporting an information flow interface is installed and run on the second terminal 160. A second user account is logged in to a second social interaction platform. The second user account may browse or publish content on the information flow interface of the social interaction platform. The second user account may further interact, through the information flow interface displayed on the social interaction platform, with an account that the second user account subscribes to.

In an embodiment, the first user account and the second user account are in a one-way subscription relationship. If the second user account publishes social content on the social interaction platform, the first user account can browse the content on the information flow interface. However, if the first user account publishes social content on the social interaction platform, the second user account cannot browse the content on the information flow interface. In another embodiment, the first user account and the second user account are in a two-way subscription relationship. If the second user account publishes social content on the social interaction platform, the first user account can browse the content on the information flow interface, and if the first user account publishes social content on the social interaction platform, the second user account can browse the content on the information flow interface. The first terminal 120 and the second terminal 160 are connected to the server 140 by using a wireless network or a wired network.

The server 140 includes at least one of a server, a plurality of servers, a cloud computing platform, and a virtualization center. For example, the server 140 includes a processor 144 and a memory 142. The memory 142 further includes a receiving module 1421, a control module 1422, and a transmitting module 1423. The receiving module 1421 is configured to receive a request transmitted by the social interaction platform, such as a request for giving a like to social content. The control module 1422 is configured to control rendering of the information flow interface. The transmitting module 1423 is configured to transmit a response to the social interaction platform, such as transmit a feedback of whether the like is successful to the social interaction platform. The server 140 is configured to provide a background service for the social interaction platform. In some embodiments, the server 140 undertakes primary computing, and the first terminal 120 and the second terminal 160 undertake secondary computing. Alternatively, the server 140 undertakes secondary computing, and the first terminal 120 and the second terminal 160 undertake primary computing. Alternatively, the server 140, the first terminal 120, and the second terminal 160 collaboratively undertake computing. In some embodiments, device types of the first terminal 120 and the second terminal 160 are the same or different. The device types include at least one of a smartphone, a smart watch, a vehicle-mounted terminal, a wearable device, a smart TV, a tablet computer, an e-book reader, an MP3 player, an MP4 player, a laptop computer, and a desktop computer. The following embodiments are based on an example in which the terminal includes a smartphone. A person skilled in the art may know that a quantity of the above terminal may be more or less. For example, only one terminal may be provided, or dozens or hundreds of or more terminals may be provided. The quantity and the device type of the terminal are not limited in the embodiments of this application.

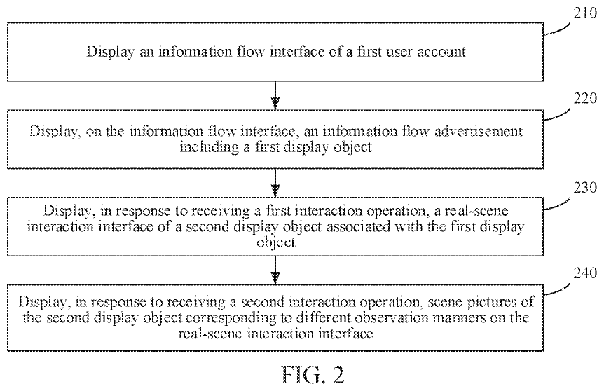

FIG. 2 is a flowchart of an information flow advertisement-based interaction method according to an exemplary embodiment of this application. For example, the method is performed by the first terminal 120 shown in FIG. 1. The method includes the following steps:

Step 210: Display an information flow interface of a first user account.

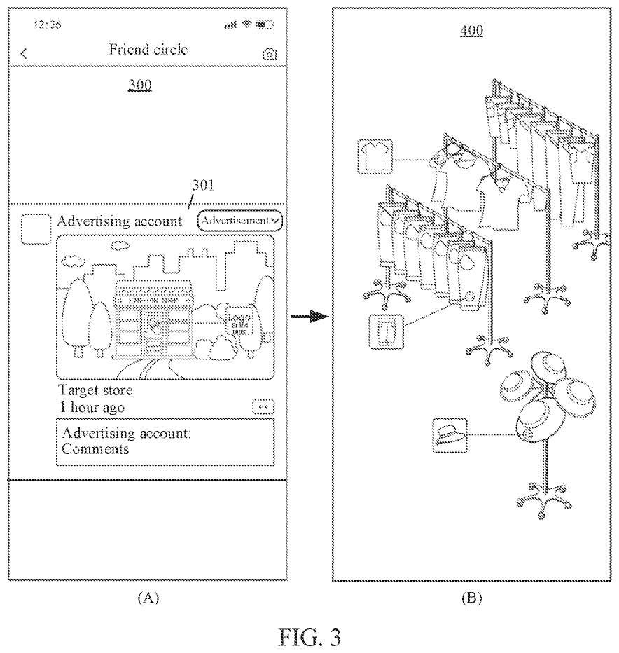

The information flow interface refers to an interface that is continuously updated and presents content to a user. The information flow interface includes social content transmitted by at least one content publishing account. In some embodiments, the information flow interface includes social content transmitted by at least one content publishing account sorted in chronological order. For example, in a friend circle of a social program, social content published by the first user account and friend accounts thereof is arranged in near-to-far order from publishing times to a current time to obtain the information flow interface. For example, Part (A) of FIG. 3 is a schematic diagram of an information flow interface 300 of the first user account. The content publishing account refers to an account publishing social content on the social interaction platform. In the embodiments of this application, the content publishing account includes at least a user account. The user account interacts, through the social interaction platform, with social content published by a user account that the user content subscribes to.

The social content refers to content published by the content publishing account. If the content publishing account is a user account, the social content may be daily updates, video forwarding, song recommendations, and the like published by the user account.

Step 220: Display, on the information flow interface, an information flow advertisement including a first display object.

The first display object refers to an overall space observed from the outside and used for accommodating recommended objects. For example, if the recommended objects are displayed through a real scene, the first display object is a physical building observed from the outside of the physical building. For example, the physical building is a physical store selling recommended commodities. In another example, if the recommended objects are displayed through a starry sky scene, the first display object is a solar system observed from the outside of the solar system. For example, in the starry sky scene, to-be-recommended recommended commodities may be suspended on stars, or the to-be-recommended recommended commodities may be provided on connecting lines between the stars. In another example, if the recommended objects are displayed through a forest scene, the first display object is a forest observed from the outside of the forest. For example, in the forest scene, the to-be-recommended recommended commodities may be hung from trees or placed on grass, or the to-be-recommended recommended commodities may be held by animals appearing in the forest scene.

In some embodiments, an information flow advertisement including a physical building is displayed on the information flow interface. The information flow advertisement includes advertising content published by an advertising account and a corresponding statement component. In some embodiments, the statement component includes a like button, a comment button, a collect button, a forward button, and the like. In some embodiments, the information flow advertisement is displayed in a form of a card. For example, an information flow card includes advertising content published by an advertising account and a corresponding statement component. For example, Part (A) of FIG. 3 shows an information flow advertisement 301 included on the information flow interface 300. The information flow advertisement 301 shown in FIG. 3 includes advertising content published by an advertising account and a corresponding statement component. A store (physical building) is displayed on the information flow advertisement 301. In some embodiments, a real-time number of online visitors currently visiting the store and/or a cumulative number of visitors who have visited the store are/is further displayed on the information flow advertisement.

The physical building refers to a building actually existing in the real world and having a closure property. The closure property may be understood as a property with a real periphery to separate the physical building from the outside. For example, the physical building includes a store, a shopping mall, a tourist attraction, an amusement park, a museum, a cafe, a restaurant, and the like. In an embodiment, a building exterior of the physical building is further displayed on the information flow advertisement. The building exterior of the physical building includes, but is not limited to, at least one of the following: a physical building, a parking lot near the physical building, a traffic light intersection near the physical building, a public transportation station near the physical building, a street near the physical building, a night view of the physical building, a landmark building near the physical building, and the like. In some embodiments, the building exterior of the physical building is used for assisting the user in understanding a geographical position, convenient transportation, and an external scenery of the physical building.

Step 230: Display, in response to receiving a first interaction operation, a real-scene interaction interface of a second display object associated with the first display object.

The first interaction operation refers to an operation for switching an interface displaying the first display object to the real-scene interaction interface.

The second display object refers to an overall environment inside the first display object. For example, if the first display object is a physical building observed from the outside, the second display object is an overall environment inside the physical building. Alternatively, the first display object is a physical building, and the second display object is a building interior of the physical building. In another example, if the first display object is a solar system observed from the outside, the second display object is an overall environment inside the solar system. In yet another example, if the first display object is a forest observed from the outside, the second display object is an overall environment inside the forest.

The real-scene interaction interface refers to an interface for displaying the second display object. In an embodiment, in response to receiving the first interaction operation, a real-scene interaction interface for displaying the building interior of the physical building is displayed.

In an embodiment, the real-scene interaction interface refers to an interface for displaying the building interior of the physical building and supporting a second interaction operation. In some embodiments, the real-scene interaction interface may be called a landing page of the information flow advertisement. The real-scene interaction interface supports mobile browsing of details in the physical building through a panoramic map, the physical building is divided into different regions according to a regular store arrival process, and different regions may be switched and moved to as guided, thereby browsing respective corners of the physical building. For example, the social interaction platform is a friend circle of a social program and the information flow advertisement is an information flow advertisement delivered by an advertising account. An advertiser may set a click jump position of the information flow advertisement (i.e., the real-scene interaction interface) on an advertising platform as a native program page, a web page, a mini-program page, an official account page, or the like. Referring to Part (B) of FIG. 3 together, Part (B) of FIG. 3 shows a real-scene interaction interface 400. A store interior (building interior) of the store (physical building) is displayed on the real-scene interaction interface 400. In an embodiment, the information flow advertisement receives a trigger operation through a statement component, and the real-scene interaction interface of the second display object associated with the first display object is displayed. In another embodiment, the information flow advertisement receives a trigger operation through a message body, and the real-scene interaction interface of the second display object associated with the first display object is displayed. The message body includes message content carried in the information flow advertisement. In an embodiment, the information flow advertisement receives a trigger operation through the statement component, and the real-scene interaction interface for displaying the building interior of the physical building is displayed. In another embodiment, the information flow advertisement receives a trigger operation through the message body, and the real-scene interaction interface for displaying the building interior of the physical building is displayed. The message body includes message content carried in the information flow advertisement.

Step 240: Display, in response to receiving a second interaction operation, scene pictures of the second display object corresponding to different observation manners on the real-scene interaction interface.

The scene pictures include recommended objects. In some embodiments, the recommended objects include recommended items. In some embodiments, the recommended items include recommended commodities. For example, the recommended objects may be a top, trousers, a hat, a backpack, and a handbag. In some embodiments, the recommended objects are preset recommended objects. In some embodiments, a first scene picture corresponding to a first observation manner is displayed on the real-scene interaction interface, and in response to the second interaction operation, the first scene picture is switched to a second scene picture corresponding to a second observation manner. The first scene picture and the second scene picture include different recommended objects. For example, the first scene picture includes a top 1 (a recommended object) and a hat 1 (a recommended object), and the second scene picture includes shoes 1 (a recommended object).

The second interaction operation refers to an operation of interacting with the second display object on the real-scene interaction interface. In some embodiments, the second interaction operation refers to an operation of interacting, on the real-scene interaction interface, with the building interior of the physical building. In some embodiments, the second interaction operation includes at least one of a screen swiping operation, a continuous touch operation, a screen single-clicking operation, a screen double-clicking operation, a continuous touch operation, a rotation operation of a mobile terminal, a moving operation of the mobile terminal, a voice control operation, and a somatosensory control operation.

In an embodiment, in response to the second interaction operation, scene pictures of the building interior corresponding to different observation manners are displayed on the real-scene interaction interface. In this application, the observation manners include manners such as image rotation and image zooming on a UI level, as well as simulation of changes in an observation perspective and an observation position in the real world.

In an embodiment, in response to the second interaction operation, the scene pictures of the second display object are rotated; and rotated scene pictures are displayed on the real-scene interaction interface. In an embodiment, in response to the second interaction operation, the scene pictures of the building interior are rotated; and a rotated building interior is displayed on the real-scene interaction interface. For example, in response to an operation of swiping left on a screen of the first user account on the real-scene interaction interface, the scene pictures of the building interior are rotated counterclockwise.

In an embodiment, in response to the second interaction operation, recommended objects in the scene pictures of the second display object are rotated; and rotated recommended objects are displayed on the real-scene interaction interface. In an embodiment, in response to the second interaction operation, recommended commodities in the scene pictures of the building interior are rotated, and rotated recommended commodities are displayed on the real-scene interaction interface.

In an embodiment, in response to the second interaction operation, display sizes of the scene pictures of the second display object are zoomed; and zoomed scene pictures are displayed on the real-scene interaction interface. In an embodiment, in response to the second interaction operation, display sizes of the scene pictures of the building interior are zoomed; and zoomed scene pictures of the building interior are displayed on the real-scene interaction interface. For example, the user double-clicks on a region on the scene pictures to enlarge the region, and the region is restored in response to the user double-clicking on the region again. For example, the user zooms the display sizes of the scene pictures through a two-finger zooming operation. In an embodiment, in response to the second interaction operation, a perspective for observing the second display object is changed; scene pictures of the second display object observed after the perspective is changed are displayed on the real-scene interaction interface; and the second interaction operation is used for simulating a scene in which a user is immersed in observing the second display object. In an embodiment, in response to the second interaction operation, a perspective for observing the building interior is changed; a building interior observed after the perspective is changed is displayed on the real-scene interaction interface; and the second interaction operation is used for simulating a scene in which the user observes the building interior inside the physical building. For example, the first interaction operation is used for bringing an immersive experience to the user, and simulating, in response to a left rotation operation of the mobile terminal, a scene in which the user turns a head left in a real scene to observe the building interior. For example, in response to an operation of swiping left on a screen, the scene in which the user turns the head left in the real scene to observe the building interior is simulated. In an embodiment, in response to the second interaction operation, a position for observing the second display object is changed; scene pictures of the second display object observed after the position is changed are displayed on the real-scene interaction interface; and the second interaction operation is used for simulating a scene in which the user is immersed in observing the second display object. In an embodiment, in response to the second interaction operation, a position for observing the building interior is changed; a building interior observed after the position is changed is displayed on the real-scene interaction interface; and the second interaction operation is used for simulating a scene in which the user observes the building interior inside the physical building. For example, the first interaction operation is used for bringing an immersive experience to the user, and simulating, in response to a forward movement operation of the mobile terminal, a scene in which the user moves forward in the real scene to observe the building interior. For example, in response to an operation of clicking left on the screen, the scene in which the user moves forward in the real scene to observe the building interior is simulated.

In some embodiments, on the real-scene interaction interface, virtual resources are further added to the building interior of the physical building by using an augmented reality (AR) technology. For example, a directional arrow to guide the user to move is displayed in a corridor of the physical building, an item icon (e.g., an item pattern) is displayed on a recommended item, an employee icon (e.g., an employee's avatar) is displayed on the recommended item, some users' comments (e.g., “The tops in this store are very nice!”) are displayed on the real-scene interaction interface, and so on.

Based on the above, the physical building is displayed on the information flow advertisement, the building interior is displayed on the real-scene interaction interface in response to the first interaction operation, and the scene pictures of the building interior corresponding to different observation manners are displayed in response to the second interaction operation. According to the above solution, types of human-computer interaction are enriched, and a scene in which the user is immersed in visiting the physical building is further simulated, thereby increasing a frequency of interaction between a user account and the information flow advertisement and increasing a click-through rate of the information flow advertisement.

For example, an operation manner (such as rotating the mobile terminal or swiping the screen) and an operation effect (such as rotating the physical building or changing the observation angle) of the second interaction operation ensure that an effect of simulating a scene in which the user is immersed in visiting the physical building can be achieved through the second interaction operation. Based on the embodiments shown in FIG. 2, between step 220 and step 230, the method further includes: displaying, in response to receiving a third interaction operation, scene pictures of the first display object corresponding to different observation manners on the information flow advertisement.

In an embodiment, the displaying, in response to receiving a third interaction operation, scene pictures of the first display object corresponding to different observation manners on the information flow advertisement includes: displaying, in response to the third interaction operation, scene pictures of the physical building corresponding to different observation manners on the information flow advertisement. The third interaction operation refers to an operation of interacting with the first display object on the information flow advertisement. In some embodiments, the third interaction operation refers to an operation of interacting with the physical building on the information flow advertisement. In some embodiments, the third interaction operation includes at least a screen swiping operation, a continuous touch operation, a screen single-clicking operation, a screen double-clicking operation, a continuous touch operation, a rotation operation of a mobile terminal, a moving operation of the mobile terminal, a voice control operation, and a somatosensory control operation.

In this application, the observation manners include manners such as image rotation and image zooming on a UI level, as well as simulation of changes in an observation angle and an observation position in the real world.

In an embodiment, in response to the third interaction operation, the scene pictures of the first display object are rotated; and rotated scene pictures are displayed on the information flow advertisement. In an embodiment, in response to the third interaction operation, the scene pictures of the physical building are rotated; and rotated scene pictures are displayed on the information flow advertisement. For example, in response to an operation of swiping left on a screen of the first user account on the information flow advertisement, the scene pictures of the physical building are rotated counterclockwise.

In an embodiment, in response to the third interaction operation, the first display object in the scene pictures of the first display object is rotated; and a rotated first display object is displayed on the information flow advertisement. In an embodiment, in response to the third interaction operation, the physical building in the scene pictures of the physical building is rotated; and a rotated physical building is displayed on the information flow advertisement.

In an embodiment, in response to the third interaction operation, display sizes of the scene pictures of the first display object are zoomed; and zoomed scene pictures are displayed on the information flow advertisement. In an embodiment, in response to the third interaction operation, display sizes of the scene pictures of the physical building are zoomed; and zoomed scene pictures are displayed on the information flow advertisement. For example, the user double-clicks on a region on the scene pictures to enlarge the region, and the region is restored in response to the user double-clicking on the region again. For example, the user zooms the display sizes of the scene pictures through a two-finger zooming operation.

In an embodiment, in response to the third interaction operation, a perspective for observing the first display object is changed; scene pictures of the first display object observed after the perspective is changed are displayed on the information flow advertisement; and the third interaction operation is used for simulating a scene in which the user is immersed in observing the first display object. In an embodiment, in response to the third interaction operation, a perspective for observing the physical building is changed; scene pictures of the physical building observed after the perspective is changed are displayed on the information flow advertisement; and the third interaction operation is used for simulating a scene in which the user observes the physical building outside the physical building. In some embodiments, the third interaction operation is used for bringing an immersive experience to the user, and simulating, in response to a left rotation operation of the mobile terminal, a scene in which the user turns the head left in the real scene to observe the physical building. For example, in response to an operation of swiping left on the screen, the scene in which the user turns the head left in the real scene to observe the physical building is simulated. In an embodiment, in response to the third interaction operation, a position for observing the first display object is changed; scene pictures of the first display object observed after the position is changed are displayed on the information flow advertisement; and the third interaction operation is used for simulating a scene in which the user is immersed in observing the first display object. In an embodiment, in response to the third interaction operation, a position for observing the physical building is changed; the physical building observed after the perspective is changed is displayed on the information flow advertisement; and the third interaction operation is used for simulating a scene in which the user observes the physical building outside the physical building. In some embodiments, the third interaction operation is used for bringing an immersive experience to the user, and simulating, in response to a forward movement operation of the mobile terminal, a scene in which the user moves forward in the real scene to observe the physical building. For example, in response to an operation of clicking left on the screen, the scene in which the user moves left in the real scene to observe the physical building is simulated. In some embodiments, on the information flow advertisement, virtual resources are further added to the scene pictures of the physical building by using the AR technology. For example, a directional arrow to guide the user to move is displayed on a street near the physical building, a building icon (such as a commodity logo or a building thumbnail) is added to the physical building, some users' comments (e.g., “The service quality in this store is super good!”) are displayed on the physical building, and so on.

For example, Part (A) of FIG. 3 shows a logo and a brand name corresponding to a store pointed out through a guide line.

Next, possible specific manners of the first interaction operation, the second interaction operation, and the third interaction operation mentioned in this application will be introduced. Regarding content of the first interaction operation:

Based on the exemplary embodiment shown in FIG. 2, step 230 “displaying, in response to receiving a first interaction operation, a real-scene interaction interface of a second display object associated with the first display object” includes at least the following possible interface switching manners. The interface switching manners shown below are sorted in no particular order.

In a first possible interface switching manner, an icon of the first display object is displayed on the information flow advertisement; and the real-scene interaction interface of the second display object associated with the first display object is displayed in response to the icon of the first display object receiving a trigger operation.

In some embodiments, a building icon is displayed in a region, in which the physical building is located, on the information flow advertisement; and the real-scene interaction interface for displaying the building interior of the physical building is displayed in response to the building icon receiving a trigger operation.

Referring to Part (A) of FIG. 3 which shows a store exterior (building exterior) of the store (physical building), a brand icon (building icon) is displayed in a region in which the store is located, and a real-scene interaction interface is displayed in response to the brand icon receiving a click operation. Part (A) of FIG. 3 further shows a click prompt: a click pattern in the figure.

In a second possible interface switching manner, the real-scene interaction interface of the second display object associated with the first display object is displayed in response to a statement component of the information flow advertisement receiving a trigger operation. The statement component is configured to provide a function for a user account to interact with the information flow advertisement. In an embodiment, the real-scene interaction interface for displaying the building interior of the physical building is displayed in response to a statement component of the information flow advertisement receiving a trigger operation. The statement component is configured to provide a function for a user account to interact with the information flow advertisement. In some embodiments, the statement component includes a like button, a collect button, a comment-related component, a forward button, a share button, and the like. The real-scene interaction interface for displaying the building interior is displayed in response to the statement component receiving a trigger operation. In an embodiment, the statement component is the like button. In some embodiments, the real-scene interaction interface of the second display object associated with the first display object is displayed in response to the like button of the information flow advertisement receiving a trigger operation. For example, the real-scene interaction interface for displaying the building interior is displayed in response to the like button receiving the trigger operation.

In an embodiment, the statement component is the comment-related component. In some embodiments, guidance content is displayed on a comment list of the information flow advertisement, the guidance content being used for guiding the first user account to make comments on the comment list; a comment copy inputted by the first user account is received in response to a copy editing operation and a copy transmitting operation; and the real-scene interaction interface of the second display object associated with the first display object is displayed based on the comment copy. For example, guidance content is displayed on a comment list of the information flow advertisement, the guidance content being used for guiding the first user account to make comments on the comment list; the comment list receives a comment copy inputted by the first user account in response to a copy editing operation and a copy transmitting operation of the user; and the real-scene interaction interface for displaying the building interior of the physical building is displayed based on the comment copy. For example, a preset question is displayed on the comment list of the information flow advertisement, the preset question corresponding to at least one preset answer; the comment list receives a comment copy inputted by the first user account in response to a copy editing operation and a copy transmitting operation of the user; and the real-scene interaction interface for displaying the building interior of the physical building is displayed when the comment copy inputted by the first user account is consistent with the preset answer.

For example, “Do you know who the spokesperson of XX brand is? Reply in the comment section. There will be a surprise if you answer correctly!” posted by the advertising account is displayed on the comment list of the information flow advertisement. When the comment copy replied by the first user account is consistent with the preset answer, the information flow advertisement displaying the building exterior is switched to the real-scene interaction interface displaying the building interior.

For example, a lottery tip is displayed on the comment list of the information flow advertisement; a comment copy inputted by the first user account is received in response to a copy editing operation and a copy transmitting operation; and the real-scene interaction interface of the second display object associated with the first display object is displayed when the comment copy meets an award condition.

For example, the lottery tip is displayed on the comment list of the information flow advertisement. The lottery tip is used for reminding the user that there is a probability of opening a hidden egg if comments are made on the comment list. The comment list receives a comment copy inputted by the first user account in response to a copy editing operation and a copy transmitting operation of the user; and the real-scene interaction interface for displaying the building interior of the physical building is displayed when the comment copy meets an award condition.

For example, “Make your comments in the comment section and there is a probability of opening a surprise. Don't miss it!” posted by the advertising account is displayed on the comment list of the information flow advertisement. The real-scene interaction interface for displaying the building interior of the physical building is displayed when the comment copy replied by the first user account is randomly selected; or the real-scene interaction interface for displaying the building interior of the physical building is displayed when the comment copy replied by the first user account includes a hidden keyword.

In a third possible interface switching manner, in response to receiving the first interaction operation, a cutscene of switching from the first display object to the second display object is displayed, and then the real-scene interaction interface of the second display object associated with the first display object is displayed. In an embodiment, in response to the information flow advertisement receiving a trigger operation, a cutscene of switching from the physical building to the building interior is displayed, and then the real-scene interaction interface for displaying the building interior of the physical building is displayed.

In response to the information flow advertisement receiving a trigger operation, a cutscene is displayed. The cutscene displays a picture observed by the user when entering the inside of the physical building from the outside of the physical building.

Based on the above, the above three possible interface switching manners provide manners of switching the information flow interface to the real-scene interaction interface, specifically including displaying the real-scene interaction interface by triggering the building icon, displaying the real-scene interaction interface by triggering the statement component, and displaying the cutscene during the switching. The above three possible interface switching manners further enrich types of human-computer interaction, thereby increasing a frequency of interaction between the user account and the information flow advertisement and increasing a click-through rate of the information flow advertisement.

Regarding content of the second interaction operation: Based on the exemplary embodiment shown in FIG. 2, step 240 “displaying, in response to receiving a second interaction operation, scene pictures of the second display object corresponding to different observation manners on the real-scene interaction interface” includes at least the following possible manners of interacting with the building interior. In a first possible manner of interacting with the scene pictures of the second display object, icons of the recommended objects in the scene pictures of the second display object are displayed on the real-scene interaction interface; and related information of one of the recommended objects is displayed in response to the icon of the recommended object receiving a trigger operation. In some embodiments, the icon of the recommended object in the scene pictures of the second display object is displayed when a duration during which the real-scene interaction interface does not receive the trigger operation exceeds a threshold. In some embodiments, the icon of the recommended object in the scene pictures of the second display object is displayed when the real-scene interaction interface receives a zoom operation for the recommended object. In some embodiments, in response to the icon of the recommended object receiving the trigger operation, other objects included in the scene pictures of the second display object and belonging to a same category as the recommended object are marked, and the category of the recommended object is prompted. In some embodiments, a detailed introduction to the recommended object is displayed in response to the icon of the recommended object receiving the trigger operation; and at least one of a purchase button, a collect button, and a shopping cart button of the recommended object is displayed.

In a first possible manner of interacting with the scene pictures of the building interior, in an embodiment, item icons of the recommended items in the physical building are displayed on the real-scene interaction interface; and related information of the recommended item is displayed in response to one of the item icons receiving a trigger operation. Referring to Part (B) of FIG. 3 which shows icons of commodities “short sleeve, pant, and hat”, for example, related information of the short sleeve is displayed in response to the icon of the short sleeve receiving a trigger operation.

In a sub-manner 1, the icons of the recommended items in the scene pictures of the building interior are displayed when a duration during which the real-scene interaction interface does not receive the trigger operation exceeds the threshold. For example, when a duration during which the user stays on a current real-scene interaction interface exceeds the threshold, it is considered that the user has an intention to pay attention to a recommended item on the current real-scene interaction interface. In this case, a hyperlink to the recommended item is marked. The hyperlink is used for jumping to a details page of the recommended item when the user clicks on the hyperlink.

In a sub-manner 2, the icon of the recommended item in the scene pictures of the second display object is displayed when the real-scene interaction interface receives a zoom operation for the recommended item. For example, when a duration during which the user zooms in on the recommended item on the real-scene interaction interface, it is considered that the user has an intention to pay attention to the recommended item on the current real-scene interaction interface. In this case, a hyperlink to the recommended item is marked. The hyperlink is used for jumping to a details page of the recommended item when the user clicks on the hyperlink.

In a sub-manner 3, in response to the item icon receiving a trigger operation, other objects included in the scene pictures of the building interior and belonging to a same category as the recommended item are marked, and the category of the recommended item is prompted.

For example, referring to Part (B) of FIG. 3, in response to the icon of the short sleeve receiving the trigger operation, an item in the scene pictures of the building interior and belonging to a same “seasonal discount” as the short sleeve are marked, and it is prompted on the interface that the short sleeve currently belongs to the category “seasonal discount”. For example, referring to Part (B) of FIG. 3, in response to the icon of the hat receiving a trigger operation, items in the scene pictures of the building interior and belonging to a similar style to the hat are marked, and it is prompted on the interface that the hat belongs to a “hip-hop style”.

In some embodiments, other items are marked by flashing item icons of the other items belonging to a same category as the recommended item. In some embodiments, the other items are marked by highlighting the item icons of the other items belonging to the same category as the recommended item.

In a sub-manner 4, a detailed introduction to the recommendation item is displayed in response to the item icon receiving a trigger operation; and at least one of a purchase button, a collect button, and a shopping cart button of the recommended item is displayed.

For example, referring to Part (B) of FIG. 3, in response to the icon of the short sleeve receiving the trigger operation, information of the short sleeve such as a price, a material, a date of production, a quantity sold, and a place of shipment is displayed, and a purchase button, a collect button, a shopping cart button, and the like of the short sleeve are further displayed. In some embodiments, in response to adding the short sleeve to a shopping cart, the shopping cart may be added to the real-scene interaction interface to simulate a scene in which the user pushes the shopping cart in a real scene.

In a second possible manner of interacting with the scene pictures of the second display object, a broadcast icon is displayed in a region, in which a worker is located, on the real-scene interaction interface; and an audio file of the worker is played in response to the broadcast icon receiving a trigger operation.

In a second possible manner of interacting with the scene pictures of the building interior, a broadcast icon is displayed in a region, in which a worker of the physical building is located, on the real-scene interaction interface; and an audio file of the worker is played in response to the broadcast icon receiving a trigger operation.

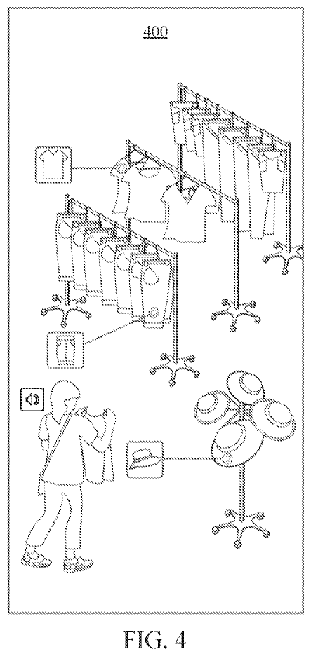

Refer to FIG. 4 together which shows that a worker is further displayed on the real-scene interaction interface. A broadcast icon is displayed around the worker. A preset audio file of the worker is played in response to the broadcast icon receiving a trigger operation. The audio file may be an introduction of the worker to an item and/or an introduction of the worker to the physical building, or the like.

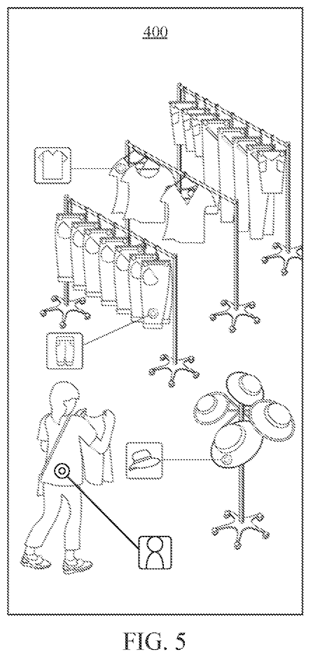

In a third possible manner of interacting with the scene pictures of the second display object, an employee icon is displayed in a region, in which the worker is located, on the real-scene interaction interface; and related information of the worker and/or the first display object is displayed in response to the employee icon receiving a trigger operation. In a third possible manner of interacting with the scene pictures of the building interior, an employee icon is displayed in a region, in which the worker of the physical building is located, on the real-scene interaction interface; and related information of the worker and/or the physical building is displayed in response to the employee icon receiving a trigger operation. Refer to FIG. 5 together which shows that a worker is further displayed on the real-scene interaction interface. An employee icon is displayed in a region in which the worker is located; and related information of the worker and/or the physical building is displayed in response to the employee icon receiving a trigger operation. For example, contact information of the worker and business hours of the physical building is displayed to facilitate the user to further understand a specific situation. For example, a social interaction platform account (such as a WeChat account) of the worker is displayed. The user may directly click on the account to initiate an application for adding friends. For example, in response to the employee icon receiving the trigger operation, customer service staff of the physical building is connected online. Online connection manners include initiating a chat with the customer service staff through a chat window, and directly making a phone call to communicate with the customer service staff. The user may directly ask the customer service staff about an item inventory, opening hours of the physical building, whether to accept commodity reservations, and the like.

In a fourth possible manner of interacting with the scene pictures of the second display object, a thumbnail map associated with the second display object is displayed on the real-scene interaction interface; in response to a functional region on the thumbnail map receiving a trigger operation, a position of the second display object currently observed is gradually moved to the functional region; and a scene picture of the second display object observed during the moving is displayed. In a fourth possible manner of interacting with the scene pictures of the building interior, a thumbnail map of the building interior is displayed on the real-scene interaction interface; in response to a functional region on the thumbnail map receiving a trigger operation, a position of the building interior currently observed is gradually moved to the functional region; and the building interior observed during the moving is displayed.

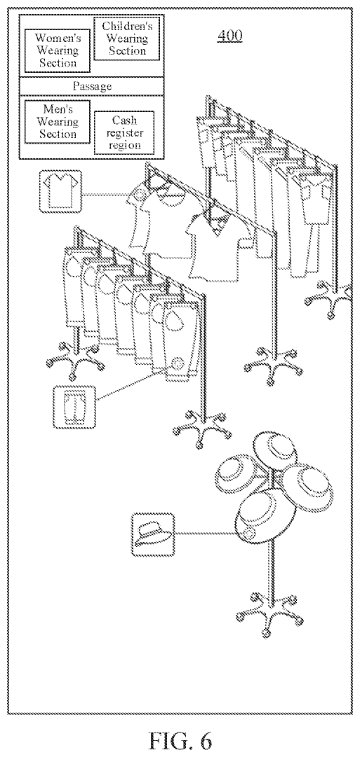

Refer to FIG. 6 together which shows that a thumbnail map inside the physical building is further displayed on an upper left side of the real-scene interaction interface 400. In some embodiments, in response to “Women's Wearing Section” on the thumbnail map receiving a trigger operation, a position of the building interior currently observed is gradually moved to the Women's Wearing Section; and the building interior observed during the moving is displayed.

In a fifth possible manner of interacting with the scene pictures of the second display object, a number of online visitors of the second display object is displayed on the real-scene interaction interface; and one is added to the number of online visitors on a real-scene interaction interface of the first user account in response to a visit operation of a second user account on the second display object. In a fifth possible manner of interacting with the scene pictures of the building interior, a number of online visitors of the physical building is displayed on the real-scene interaction interface; and one is added to the number of online visitors on the real-scene interaction interface of the first user account in response to a trigger operation of the second user account on the information flow advertisement.

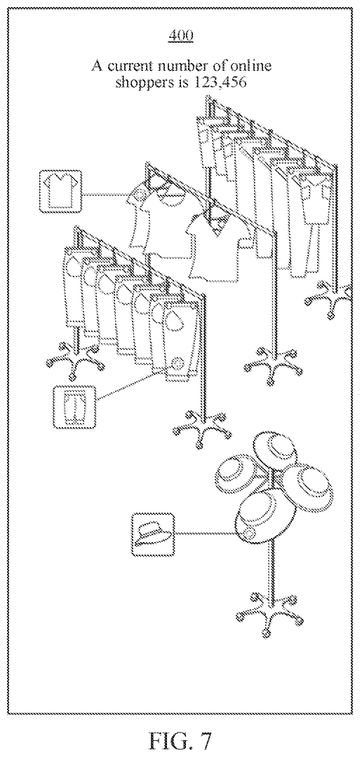

Referring to FIG. 7 together which shows that “A current number of online shoppers is 123,456” is further displayed on the real-scene interaction interface 400, one is added to the number of online visitors on the real-scene interaction interface of the first user account in response to the trigger operation of the second user account on the information flow advertisement, that is, in response to another user visiting the building interior of the physical building.

Based on the above, the above five possible manners of interacting with the building interior specifically include an interaction manner of interacting by triggering an item icon, an interaction manner of interacting by triggering a speaker icon, an interaction manner of interacting by triggering an employee icon, an interaction manner of interacting by triggering a thumbnail map, and an interaction manner of displaying a number of online visitors on the real-scene interaction interface, which further enriches types of human-computer interaction, thereby increasing a frequency of interaction between the user account and the real-scene interaction interface and increasing a click-through rate of the information flow advertisement.

Regarding content of the third interaction operation: In a first possible manner of interacting with the scene pictures of the first display object, a first scene switching control is displayed on the information flow advertisement; a first display object in a current period is switched to a first display object in a recommended period in response to the first scene switching control receiving a trigger operation; and the first display object in the recommended period is displayed on the information flow advertisement. In a first possible manner of interacting with the scene pictures of the physical building:

Firstly, the first scene switching control is displayed on the information flow advertisement. The first scene switching control may be located on a message body of the information flow advertisement. The first scene switching control may alternatively be located at any position outside the message body. For example, the first scene switching control is located below the message body, or the first scene switching control is located next to the statement component (such as the like button or the comment button).

Then, a physical building in a current period is switched to a physical building in a recommended period in response to the first scene switching control receiving the trigger operation. In some embodiments, the first scene switching control is expressed in a form of a timeline in the information flow advertisement. At least two time nodes exist on the timeline. The time nodes corresponding to physical buildings in different time periods. For example, the timeline includes time nodes of four seasons: spring, summer, autumn, and winter. In another example, the timeline includes four time nodes: morning, afternoon, dusk, and night. In response to dragging the timeline from left to right, physical buildings corresponding to the four time nodes may be sequentially switched.

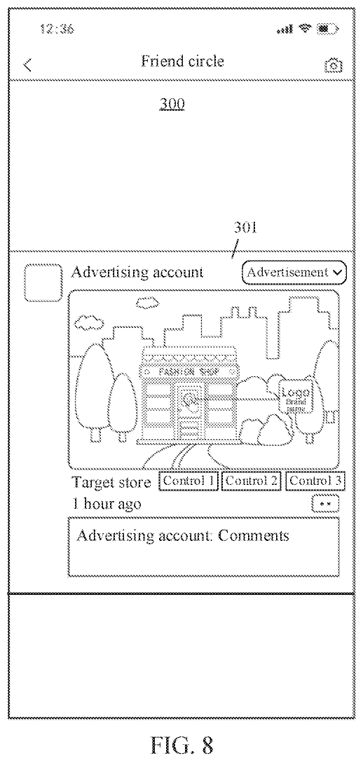

In some embodiments, the first scene switching control includes at least two sub-buttons in the information flow advertisement. Different sub-buttons correspond to physical buildings in different time periods. For example, there are four sub-buttons respectively corresponding to physical buildings in the four seasons: spring, summer, autumn, and winter. In another example, there are four sub-buttons respectively corresponding to physical buildings at four time points: morning, afternoon, dusk, and night. In response to any one of the sub-buttons receiving a click operation, the physical building corresponding to the sub-button is switched to and displayed. Referring to FIG. 8 together which shows three sub-buttons “Control 1, Control 2, and Control 3” of the first scene switching control, the three sub-buttons respectively correspond to physical buildings in three time periods. Finally, the physical building in the recommended period is displayed on the information flow advertisement.

In a second possible manner of interacting with the scene pictures of the first display object, a second scene switching control is displayed on the information flow advertisement; a first display object corresponding to a current spatial position is switched to a first display object corresponding to a recommended spatial position in response to the second scene switching control receiving a trigger operation; the first display object corresponding to the recommended spatial position and the first display object corresponding to the current spatial position are different first display objects; and the first display object corresponding to the recommended spatial position is displayed on the information flow advertisement. In a second possible manner of interacting with the scene pictures of the physical building, firstly, the second scene switching control is displayed on the information flow advertisement. The second scene switching control may be located on the message body of the information flow advertisement. The second scene switching control may alternatively be located at any position outside the message body. For example, the second scene switching control is located below the message body, or the second scene switching control is located next to the statement component (such as the like or comment button). Then, a physical building corresponding to the current spatial position is switched to a physical building corresponding to the recommended spatial position in response to the second scene switching control receiving the trigger operation. The physical building corresponding to the recommended spatial position and the physical building corresponding to the current spatial position are different physical buildings. In some embodiments, the second scene switching control includes at least two sub-buttons in the information flow advertisement. Different sub-buttons correspond to physical buildings in different time periods. For example, a brand has three large stores around the world, and three sub-buttons respectively corresponding to a Beijing store, a London store, and a Paris store exist in the information flow advertisement. A physical building of the Beijing store currently displayed is switched to a physical building of the London store in response to the sub-button of the London store receiving a click operation.

Referring to FIG. 8 together which shows three sub-buttons “Control 1, Control 2, and Control 3” of the second scene switching control, the three sub-buttons respectively corresponding to physical buildings at three spatial positions.

Finally, the physical building corresponding to the recommended spatial position is displayed on the information flow advertisement.

In a third possible manner of interacting with the scene pictures of the first display object, a third scene switching control is displayed on the information flow advertisement; a first display object corresponding to a current spatial position in a current period is switched to a first display object corresponding to a recommended spatial position in a recommended period in response to the third scene switching control receiving a trigger operation; and the first display object corresponding to the recommended spatial position in the recommended period is displayed on the information flow advertisement.

In a third possible manner of interacting with the scene pictures of the physical building, firstly, the third scene switching control is displayed on the information flow advertisement. The third scene switching control may be located on the message body of the information flow advertisement. The third scene switching control may alternatively be located at any position outside the message body. For example, the third scene switching control is located below the message body, or the third scene switching control is located next to the statement component (such as the like or comment button). Then, a physical building corresponding to the current spatial position in the current period is switched to a physical building corresponding to the recommended spatial position in the recommended period in response to the third scene switching control receiving the trigger operation. In some embodiments, the third scene switching control includes at least two sub-buttons in the information flow advertisement. Different sub-buttons correspond to physical buildings corresponding to different spatial positions in different time periods. For example, a brand has three large stores around the world, and two sub-buttons respectively corresponding to corresponding to a Beijing store on National Day and a New York store on Christmas Day exist in the information flow advertisement. The Beijing store on National Day currently displayed is switched to the New York store on Christmas Day in response to the sub-button corresponding to the New York store on Christmas Day receiving a click operation.

Referring to FIG. 8 together which shows three sub-buttons “Control 1, Control 2, and Control 3” of the third scene switching control, the three sub-buttons respectively correspond to physical buildings corresponding to three spatial positions in three time periods.

Finally, the physical building corresponding to the recommended spatial position in the recommended period is displayed on the information flow advertisement.

Based on the above, the above three possible manners of interacting with the building exterior provide a method for switching the building exterior, specifically including switching a building exterior of a same physical building in different time periods, building exteriors of different physical buildings in a same time period, and building exteriors of different physical buildings in different time periods, which further enriches types of human-computer interaction, thereby increasing a frequency of interaction between the user account and the information flow advertisement and increasing a click-through rate of the information flow advertisement.

Based on the exemplary embodiment shown in FIG. 2, the method further includes step S1:

Step S1: Pre-load multimedia materials of the first display object and the second display object.

In an embodiment, step 220 in FIG. 2 may be replaced with: displaying, on the information flow interface, the information flow advertisement including the first display object when the multimedia material of the first display object is successfully pre-loaded. In an embodiment, step 230 and step 240 in FIG. 2 may be replaced with: displaying, in response to receiving the first interaction operation, the real-scene interaction interface of the second display object associated with the first display object when the multimedia material of the second display object is successfully pre-loaded; and displaying, in response to receiving the second interaction operation, the scene pictures of the second display object corresponding to the different observation manners on the real-scene interaction interface. In an embodiment, multimedia materials of the physical building and the building interior are pre-loaded.

The multimedia materials refer to files for displaying the physical building in multimedia forms such as an image, an audio, and a video. The multimedia materials are obtained by pre-collecting multimedia files of field scenes and performing multimedia processing on the multimedia files.

In an embodiment, a step of generating a multimedia material includes: firstly, collecting images of a field scene of the physical building by using a plurality of lenses; next, splicing the images collected by the plurality of lenses into a 360-degree panorama through an image stitching algorithm and image information processing; then, repeatedly generating a plurality of 360-degree panoramas at a plurality of positions, and further shooting a recommended item at 360 degrees. Finally, all the 360-degree panoramas constitute a complete multimedia material. The generated multimedia material may achieve an effect of moving for observation and changing a perspective for observation in a virtual space. At the same time, a recommended commodity may be externally browsed in all directions. In an embodiment, before the information flow advertisement for displaying the physical building is displayed on the information flow interface, the terminal pre-loads the multimedia materials of the physical building and the building interior from the server. The scene pictures of the physical building are displayed when the multimedia material of the physical building is successfully pre-loaded. The building interior of the physical building is displayed when the multimedia material of the building interior is successfully pre-loaded. In an embodiment, the information flow advertisement for displaying the physical building is displayed on the information flow interface when the multimedia material of the physical building is successfully pre-loaded; and the physical building corresponding to the different observation manners is displayed on the information flow advertisement in response to the first interaction operation. In an embodiment, when the multimedia material of the building interior is successfully pre-loaded, the real-scene interaction interface for displaying the building interior of the physical building is displayed in response to the information flow advertisement receiving a trigger operation; and the building interior corresponding to the different observation manners is displayed on the real-scene interaction interface in response to the second interaction operation.

Based on the above, the physical building is displayed on the information flow advertisement and the building interior is displayed on the real-scene interaction interface by pre-loading a real-scene material of the physical building, which ensures an update speed of the information flow interface. Before the user swipes to next information flow card, related resources have been loaded in advance, which ensures implementation of the above information flow advertisement-based interaction method.

In this application, to facilitate illustration, the accompanying drawings of the specification are based on an example in which the physical building is a store. However, the solution of this application cannot be interpreted as being only applicable to the store, because other types of physical buildings may also realize the real-scene interaction manner based on a same concept.

For example, if the physical building is a tourist attraction, the information flow advertisement displays the tourist attraction observed from the outside, and an interior of the tourist attraction is displayed on the real-scene interaction interface, which enables the user to be immersed in a scenic spot without leaving home. For example, an information flow advertisement including the tourist attraction is displayed on the information flow interface; and the information flow advertisement displays a building exterior of the tourist attraction, for example, an entrance to the tourist attraction. A real-scene interaction interface of an interior of the tourist attraction associated with the tourist attraction is displayed in response to receiving the first interaction operation. The interior of the tourist attraction may be a scenic spot or a building in the tourist attraction. Scene pictures of the interior of the tourist attraction corresponding to different observation manners are displayed on the real-scene interaction interface in response to receiving the second interaction operation.

For example, if the physical building is a museum, the information flow advertisement displays the museum as observed from the outside, and an interior of the museum is displayed on the real-scene interaction interface, which enables the user to visit cultural relics on site and learn history with explanations of a docent without leaving home. For example, an information flow advertisement including the museum is displayed on the information flow interface; and the information flow advertisement displays a building exterior of the museum, for example, an entrance to the museum. A real-scene interaction interface of an interior of the museum associated with the tourist attraction is displayed in response to receiving the first interaction operation. The interior of the museum may be an exhibition hall or a display in the museum. Scene pictures of the interior of the museum corresponding to different observation manners are displayed on the real-scene interaction interface in response to receiving the second interaction operation.

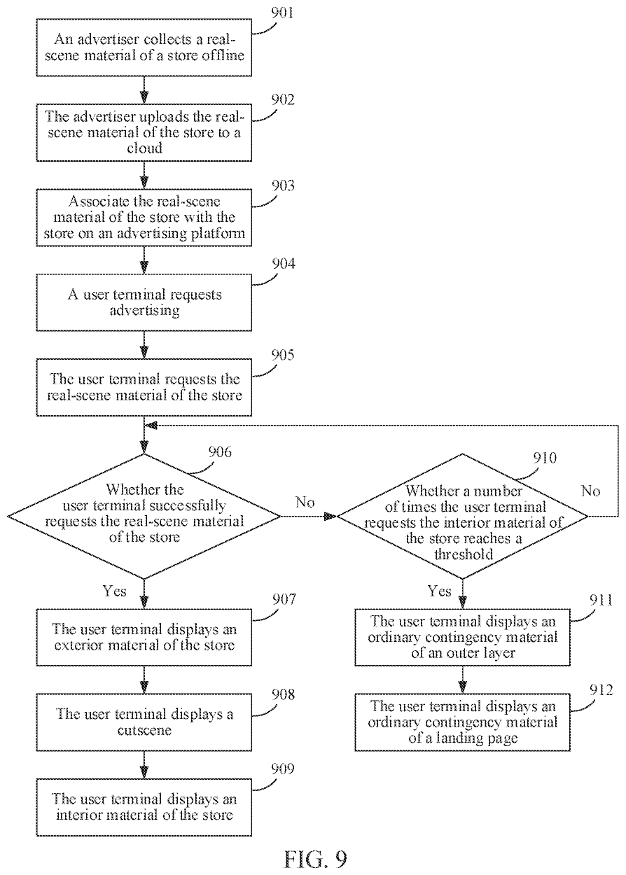

FIG. 9 is a flowchart of an information flow advertisement-based interaction method according to an exemplary embodiment of this application. The method includes the following steps: Step 901: An advertiser collects a real-scene material of a store offline.

In terms of collecting real-scene material information of an offline store, the advertiser collects images by multi-lens+multi-position, and obtains the real-scene material of the store according to the collected images through an image splicing algorithm and image information processing. For example, the advertiser captures images at 360 degrees at a position A and splices all the captured images at the position A into a 360-degree panorama through the image splicing algorithm and image information processing, and also captures images at 360 degrees at a position B and splices all the captured images at the position B into a 360-degree panorama through the image splicing algorithm and image information processing. Based on this, the advertiser captures 360-degree panoramas of all the positions. In some embodiments, shooting positions when the material of the store is collected are in one-to-one correspondence to positions when the building interior is observed on the real-scene interaction interface; or the positions when the building interior is observed on the real-scene interaction interface are obtained by interpolating the shooting positions when the material of the store is collected. That is, granularity of a series of observation positions may be smaller than that of a series of collection positions, and the user may have no clear sense of pause when moving on the real-scene interaction interface. For example, the real-scene material is a building exterior and/or a building interior of the store. In some embodiments, the real-scene material may be a 360-degree panorama.

In some embodiments, the advertiser also shoots the building exterior of the physical building at 360 degrees in different periods and at different spatial positions, to support the above first to third possible manners of interacting with the building exterior.

In some embodiments, the advertiser also shoots a recommended commodity inside the building at 360 degrees, to support rotation of the recommended commodity on the real-scene interaction interface and all-round browsing of the recommended commodity. In some embodiments, the advertiser also sets item icons on items inside the building, to support the above first possible manner of interacting with the building interior. In some embodiments, the advertiser also sets a broadcast icon or an employee icon on a worker inside the building, to support the above second or third possible manner of interacting with the building interior. In some embodiments, the advertiser also pre-acquires an audio file of the worker, to support the above second possible manner of interacting with the building interior. In some embodiments, the advertiser also makes a map of the interior of the building in advance, to support the above fourth possible manner of interacting with the building interior.

Step 902: The advertiser uploads the real-scene material of the store to a cloud; and the advertiser uploads the collected real-scene material of the store to the cloud.

Step 903: An advertising platform associates the real-scene material of the store; and the advertiser or an operator of the advertising platform associates the real-scene material of the store with the store on the advertising platform. In some embodiments, information of the store is associated with the real-scene material of the store stored in the cloud on the advertising platform, and the real-scene material of the store is set to be in a state of waiting for a request for invocation.

Step 904: A user terminal requests advertising. When an advertisement is delivered to the user terminal, firstly, the user terminal initiates a request for receiving advertising content, and the advertising platform transmits regular advertising content to the user terminal, including an ordinary contingency material of an outer layer and an ordinary contingency material of a landing page. The materials are pre-uploaded on the advertising platform by the advertiser.

Step 905: The user terminal requests the real-scene material of the store.

The user terminal transmits a request to the cloud via the advertising platform to request the cloud to transmit the real-scene material of the store.

Step 906: It is determined whether the user terminal successfully requests the real-scene material of the store. If the user terminal successfully requests the real-scene material of the store, step 907 is performed. If the user terminal does not successfully request the real-scene material of the store, step 910 is performed.

Step 907: The user terminal displays an exterior material of the store.

The user terminal displays the exterior material of the store on an information flow advertisement of an information flow interface.

Step 908: The user terminal displays a cutscene. In an embodiment, the user terminal displays the cutscene after receiving a trigger operation on the information flow advertisement. The cutscene displays a picture observed during entry of the user into the store from the outside of the store.

Step 909: The user terminal displays an interior material of the store.

In an embodiment, the user terminal displays a landing page of the advertisement, and displays the interior material of the store on the landing page of the advertisement.

Step 910: Determine whether a number of times the user terminal requests the interior material of the store reaches a threshold.

If the number of times the user terminal requests the interior material of the store reaches the threshold, step 911 is performed. If the number of times the user terminal requests the interior material of the store does not reach the threshold, step 905 is performed again. In some embodiments, the threshold is 3.

Step 911: The user terminal displays the ordinary contingency material of the outer layer. In an embodiment, when a number of times the user terminal requests the real-scene material of the store reaches a threshold, the ordinary contingency material of the outer layer is displayed on the information flow advertisement of the user terminal. The ordinary contingency material of the outer layer is a preset material that will be displayed in the information flow advertisement when the real-scene material of the store cannot be displayed, for example, at least one of an advertisement image, advertisement text, an advertisement video, and the like. Further, for the exterior material, virtual sources are added to the scene pictures of the physical building through the AR technology. For the ordinary contingency material of the outer layer, no virtual sources are added through the AR technology.

Step 912: The user terminal displays the ordinary contingency material of the landing page. In an embodiment, in response to the information flow advertisement of the user terminal receiving a trigger operation, the landing page of the advertisement is entered.

When the number of times the user terminal requests the real-scene material of the store reaches the threshold, the ordinary contingency material of the landing page is displayed on the landing page. The ordinary contingency material of the landing page is a preset material that will be displayed on the landing page when the real-scene material of the store cannot be displayed, for example, at least one of an advertisement web page, an advertisement details image, an advertisement video play page, and the like. Further, the interior material may be called a real-scene interaction interface. On the real-scene interaction interface, virtual sources are added to the building interior of the physical building through the AR technology. For the ordinary contingency material of the landing page, no virtual sources are added through the AR technology.

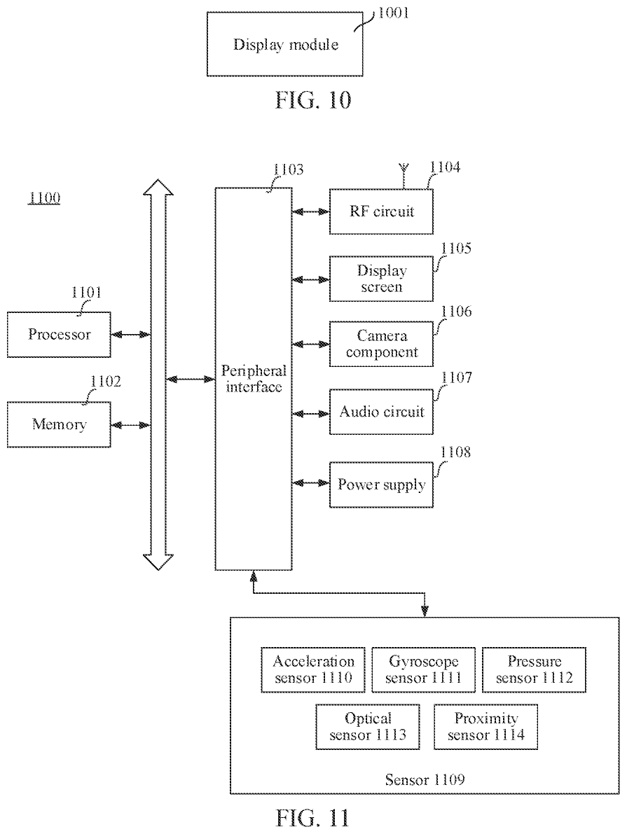

FIG. 10 shows an information flow advertisement-based interaction apparatus according to an exemplary embodiment of this application. The apparatus includes:

a display module 1001 configured to perform step 210 to step 240 in the embodiments of FIG. x.

In an exemplary embodiment, the display module 1001 is further configured to rotate, in response to the second interaction operation, the scene pictures of the second display object; and display rotated scene pictures on the real-scene interaction interface. In an exemplary embodiment, the display module 1001 is further configured to rotate, in response to the second interaction operation, recommended objects in the scene pictures of the second display object; and display rotated recommended objects on the real-scene interaction interface. In an exemplary embodiment, the display module 1001 is further configured to zoom, in response to the second interaction operation, the scene pictures of the second display object; and display zoomed scene pictures on the real-scene interaction interface. In an exemplary embodiment, the display module 1001 is further configured to change, in response to the second interaction operation, a perspective for observing the second display object; display, on the real-scene interaction interface, scene pictures of the second display object observed after the perspective is changed. The second interaction operation is used for simulating a scene in which a user is immersed in observing the second display object. In an exemplary embodiment, the display module 1001 is further configured to change, in response to the second interaction operation, a perspective for observing the second display object; display, on the real-scene interaction interface, scene pictures of the second display object observed after the perspective is changed. The second interaction operation is used for simulating a scene in which the user is immersed in observing the second display object.

In an exemplary embodiment, the display module 1001 is further configured to display icons of the recommended objects in the scene pictures of the second display object on the real-scene interaction interface; and display, in response to the icon of one of the recommended objects receiving a trigger operation, related information of the recommended object. In an exemplary embodiment, the display module 1001 is further configured to display the icon of the recommended object in the scene pictures of the second display object when a duration during which the real-scene interaction interface does not receive the trigger operation exceeds a threshold.

In an exemplary embodiment, the display module 1001 is further configured to display the icon of the recommended object in the scene pictures of the second display object when the real-scene interaction interface receives a zoom operation for the recommended object. In an exemplary embodiment, the display module 1001 is further configured to mark, in response to the icon of the recommended object receiving the trigger operation, other objects included in the scene pictures of the second display object and belonging to a same category as the recommended object, and prompt the category of the recommended object.

In an exemplary embodiment, the display module 1001 is further configured to display a detailed introduction to the recommended object in response to the icon of the recommended object receiving the trigger operation; and display at least one of a purchase button, a collect button, and a shopping cart button of the recommended object. In an exemplary embodiment, the scene pictures of the second display object further include a worker. The display module 1001 is further configured to display a broadcast icon in a region, in which a worker is located, on the real-scene interaction interface; and play an audio file of the worker in response to the broadcast icon receiving a trigger operation. In an exemplary embodiment, the scene pictures of the second display object further include a worker. The display module 1001 is further configured to display an employee icon in a region, in which the worker is located, on the real-scene interaction interface; and display related information of the worker and/or the first display object in response to the employee icon receiving a trigger operation.

In an exemplary embodiment, the display module 1001 is further configured to display, on the real-scene interaction interface, a thumbnail map associated with the second display object; gradually move, in response to a functional region on the thumbnail map receiving a trigger operation, a position of the second display object currently observed to the functional region; and display a scene picture of the second display object observed during the moving. In an exemplary embodiment, the display module 1001 is further configured to display, on the real-scene interaction interface, a number of online visitors of the second display object; and add, in response to a visit operation of a second user account on the second display object, one to the number of online visitors on a real-scene interaction interface of the first user account. In an exemplary embodiment, the display module 1001 is further configured to display, on the information flow advertisement, an icon of the first display object; and display, in response to the icon of the first display object receiving a trigger operation, the real-scene interaction interface of the second display object associated with the first display object. In an exemplary embodiment, the display module 1001 is further configured to display, in response to receiving the first interaction operation, a cutscene of switching from the first display object to the second display object, and then display the real-scene interaction interface of the second display object associated with the first display object.

In an exemplary embodiment, the display module 1001 is further configured to display, in response to a statement component of the information flow advertisement receiving a trigger operation, the real-scene interaction interface of the second display object associated with the first display object. The statement component is configured to provide a function for a user account to interact with the information flow advertisement. In an exemplary embodiment, the display module 1001 is further configured to display guidance content on a comment list of the information flow advertisement, the guidance content being used for guiding the first user account to make comments on the comment list; receive, in response to a copy editing operation and a copy transmitting operation, a comment copy inputted by the first user account; and display, based on the comment copy, the real-scene interaction interface of the second display object associated with the first display object.

In an exemplary embodiment, the display module 1001 is further configured to display a preset question on the comment list of the information flow advertisement, the preset question corresponding to at least one preset answer; receive, in response to a copy editing operation and a copy transmitting operation, a comment copy inputted by the first user account; and display, when the comment copy inputted by the first user account is consistent with the preset answer, the real-scene interaction interface of the second display object associated with the first display object.

In an exemplary embodiment, the display module 1001 is further configured to display a lottery tip on the comment list of the information flow advertisement; receive, in response to a copy editing operation and a copy transmitting operation, a comment copy inputted by the first user account; and display, when the comment copy meets an award condition, the real-scene interaction interface of the second display object associated with the first display object.

In an exemplary embodiment, the display module 1001 is further configured to display, in response to the like button of the information flow advertisement receiving a trigger operation, the real-scene interaction interface of the second display object associated with the first display object.

In an exemplary embodiment, the display module 1001 is further configured to display, in response to receiving a third interaction operation, scene pictures of the first display object corresponding to different observation manners on the information flow advertisement.

In an exemplary embodiment, the display module 1001 is further configured to rotate, in response to the third interaction operation, the scene pictures of the first display object; and display rotated scene pictures on the information flow advertisement.

In an exemplary embodiment, the display module 1001 is further configured to rotate, in response to the third interaction operation, the first display object in the scene pictures of the first display object; and display a rotated first display object on the information flow advertisement.

In an exemplary embodiment, the display module 1001 is further configured to zoom, in response to the third interaction operation, display sizes of the scene pictures of the first display object; and display zoomed scene pictures on the information flow advertisement.

In an exemplary embodiment, the display module 1001 is further configured to change, in response to the third interaction operation, a perspective for observing the first display object; and display, on the information flow advertisement, scene pictures of the first display object observed after the perspective is changed. The third interaction operation is used for simulating a scene in which the user is immersed in observing the first display object.

In an exemplary embodiment, the display module 1001 is further configured to change, in response to the third interaction operation, a position for observing the first display object; and display, on the information flow advertisement, scene pictures of the first display object observed after the position is changed. The third interaction operation is used for simulating a scene in which the user is immersed in observing the first display object.

In an exemplary embodiment, the display module 1001 is further configured to display a first scene switching control on the information flow advertisement; switch, in response to the first scene switching control receiving a trigger operation, a first display object in a current period to a first display object in a recommended period; and display the first display object in the recommended period on the information flow advertisement.

In an exemplary embodiment, the display module 1001 is further configured to display a second scene switching control on the information flow advertisement; switch, in response to the second scene switching control receiving a trigger operation, a first display object corresponding to a current spatial position to a first display object corresponding to a recommended spatial position; the first display object corresponding to the recommended spatial position and the first display object corresponding to the current spatial position being different first display objects; and display, on the information flow advertisement, the first display object corresponding to the recommended spatial position. In an exemplary embodiment, the display module 1001 is further configured to display a third scene switching control on the information flow advertisement; switch, in response to the third scene switching control receiving a trigger operation, a first display object corresponding to a current spatial position in a current period to a first display object corresponding to a recommended spatial position in a recommended period; and display, on the information flow advertisement, the first display object corresponding to the recommended spatial position in the recommended period.

In an exemplary embodiment, the display module 1001 is further configured to pre-load multimedia materials of the first display object and the second display object; display, on the information flow interface, the information flow advertisement including the first display object when the multimedia material of the first display object is successfully pre-loaded; display, in response to receiving the first interaction operation, the real-scene interaction interface of the second display object associated with the first display object when the multimedia material of the second display object is successfully pre-loaded; and display, in response to receiving the second interaction operation, the scene pictures of the second display object corresponding to the different observation manners on the real-scene interaction interface.

Based on the above, the above apparatus displays the first display object on the information flow advertisement, displays, in response to the first interaction operation, the real-scene interaction interface of the second display object, and displays, in response to the second interaction operation, the scene pictures of the second display object corresponding to the different observation manners. According to the above solutions, types of human-computer interaction are enriched, thereby increasing a frequency of interaction between the user account and the information flow advertisement and increasing a click-through rate of the information flow advertisement.

Refer to FIG. 11 which is a schematic structural diagram of a computer device 1100 according to an exemplary embodiment of this application. The computer device 1100 may be a portable mobile terminal, for example, a smartphone, a tablet computer, a Moving Picture Experts Group Audio Layer III (MP3) player, or a Moving Picture Experts Group Audio Layer IV (MP4) player. The computer device 1100 may also be referred to as another name such as user equipment or a portable terminal. Generally, the computer device 1100 includes a processor 1101 and a memory 1102. The processor 1101 may include one or more processing cores, for example, a 4-core processor or an 8-core processor. The processor 1101 may be implemented in at least one hardware form of a digital signal processor (DSP), a field-programmable gate array (FPGA), and a programmable logic array (PLA). The processor 1101 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1101 may be integrated with a graphics processing unit (GPU). The GPU is configured to render and draw content that needs to be displayed on a display screen. In some embodiments, the processor 1101 may further include an artificial intelligence (AI) processor. The AI processor is configured to process computing operations related to machine learning. The memory 1102 may include one or more computer-readable storage media. The computer-readable storage medium may be tangible and non-transient. The memory 1102 may further include a high-speed random access memory and a nonvolatile memory, for example, one or more disk storage devices or flash storage devices. In some embodiments, the non-transitory computer-readable storage medium in the memory 1102 is configured to store at least one instruction, and the at least one instruction is configured to be executed by the processor 1101 to implement the information flow advertisement-based interaction method provided in the embodiments of this application.

In some embodiments, the computer device 1100 may alternatively include: a peripheral interface 1103 and at least one peripheral. Specifically, the peripheral includes: at least one of a radio frequency (RF) circuit 1104, a touch display screen 1105, a camera component 1106, an audio circuit 1107, and a power supply 1108.

The peripheral interface 1103 may be configured to connect the at least one peripheral related to input/output (I/O) to the processor 1101 and the memory 1102. In some embodiments, the processor 1101, the memory 1102 and the peripheral device interface 1103 are integrated on a same chip or circuit board. In some other embodiments, any one or two of the processor 1101, the memory 1102, and the peripheral device interface 1103 may be implemented on a single chip or circuit board, which is not limited in this embodiment. The RF circuit 1104 is configured to receive and transmit an RF signal, also referred to as an electromagnetic signal. The RF circuit 1104 communicates with a communication network and other communication devices through the electromagnetic signal. The RF 1104 may further include a circuit related to near field communication (NFC). The touch display screen 1105 is configured to display a user interface (UI). The UI may include a graph, text, an icon, a video, and any combination thereof. The camera component 1106 is configured to collect images or videos. In some embodiments, the camera component 1106 includes a front-facing camera and a rear-facing camera. The audio circuit 1107 is configured to provide an audio interface between the user and the computer device 1100. The audio circuit 1107 may include a microphone and a speaker. The microphone is configured to collect sound waves of a user and an environment, convert the sound waves into an electrical signal, and input the electrical signal to the processor 1101 for processing, or input the electrical signal to the RF circuit 1104 for implementing voice communication. The power supply 1108 is configured to supply power to components in the computer device 1100. The power supply 1108 may be an alternating current, a direct current, a primary battery, or a rechargeable battery. In some embodiments, the computer device 1100 further includes one or more sensors 1109. The one or more sensors 1109 include, but are not limited to, an acceleration sensor 1110, a gyroscope sensor 1111, a pressure sensor 1112, an optical sensor 1113, and a proximity sensor 1114.

The acceleration sensor 1110 may detect a magnitude of acceleration on three coordinate axes of a coordinate system established with the computer device 1100. The gyroscope sensor 1111 may detect a body direction and a rotation angle of the computer device 1100. The pressure sensor 1112 may be disposed at a side frame of the computer device 1100 and/or a lower layer of the touch display screen 1105. An operable control on the UI is controlled by detecting a holding signal of the user on the computer device 1100 and/or according to a pressure operation of the user on the touch display screen 1105. The optical sensor 1113 is configured to collect ambient light intensity. The proximity sensor 1114, also referred to as a range sensor, is generally disposed on a front surface of the computer device 1100. The proximity sensor 1114 is configured to acquire a distance between the user and the front surface of the computer device 1100.

It may be understood that the structure shown in FIG. 11 constitutes no limitation on the computer device 1100, which may include more or fewer components than those shown in the figure, or some components may be combined, or a different component deployment may be used.

An embodiment of this application further provides a computer device. The computer device includes a processor and a memory. The memory stores at least one instruction, at least one program, and a code set or an instruction set. The at least one instruction, the at least one program, the code set or the instruction set is loaded and executed by the processor to implement the information flow advertisement-based interaction method provided in the above method embodiments.

This application further provides a non-transitory computer-readable storage medium. The storage medium stores at least one instruction, and at least one instruction is loaded and executed by a processor to implement the information flow advertisement-based interaction method provided in the above method embodiments.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. This application provides a computer program product or a computer program. The computer program product or the computer program includes a computer instruction. The computer instruction is stored in a computer-readable storage medium. A processor of a computer device reads the computer instruction from the computer-readable storage medium, and the processor executes the computer instruction to cause the computer device to implement the information flow advertisement-based interaction method provided in the above method embodiments.

What is claimed is:

1. An information flow advertisement-based interaction method performed by a computer device, the method comprising:
displaying an information flow interface of a first user account, the information flow interface comprising social content transmitted by at least one content publishing account;
displaying, on the information flow interface, an information flow advertisement comprising a first display object;
in response to receiving a first interaction operation on the first display object, displaying a real-scene interaction interface of a second display object associated with the first display object, wherein the second display object represents a physical building; and
in response to receiving a second interaction operation on the second display object, displaying scene pictures of the second display object corresponding to different observation manners on the real-scene interaction interface, the scene pictures comprising recommended objects located in the physical building.

2. The method according to claim 1, wherein the displaying scene pictures of the second display object corresponding to different observation manners on the real-scene interaction interface, the scene pictures comprising recommended objects located in the physical building comprises at least one of:
rotating the scene pictures of the second display object;
rotating the recommended objects in the scene pictures of the second display object;
zooming display sizes of the scene pictures of the second display object;
changing a perspective for observing the second display object for simulating a scene in which a user is immersed in observing the second display object; and
changing a position for observing the second display object for simulating a scene in which the user is immersed in observing the second display object.

3. The method according to claim 1, wherein the displaying scene pictures of the second display object corresponding to different observation manners on the real-scene interaction interface comprises:
displaying, on the real-scene interaction interface, icons of the recommended objects in the scene pictures of the second display object; and
displaying, in response to the icon of one of the recommended objects receiving a trigger operation, related information of the recommended object.

4. The method according to claim 1, wherein the displaying scene pictures of the second display object corresponding to different observation manners on the real-scene interaction interface comprises:
displaying a broadcast icon on the real-scene interaction interface; and
playing an audio file associated with the broadcast icon in response to the broadcast icon receiving a trigger operation.

5. The method according to claim 1, wherein the displaying scene pictures of the second display object corresponding to different observation manners on the real-scene interaction interface comprises:
displaying an employee icon on the real-scene interaction interface; and
in response to the employee icon receiving a trigger operation, sending an inquiry to an employee in the physical building corresponding to the employee icon.

6. The method according to claim 1, wherein the displaying scene pictures of the second display object corresponding to different observation manners on the real-scene interaction interface comprises:
displaying, on the real-scene interaction interface, a thumbnail map associated with the second display object;
in response to a functional region on the thumbnail map receiving a trigger operation, gradually moving a position of the second display object currently observed to the functional region; and
displaying a scene picture of the second display object observed during the moving.

7. The method according to claim 1, wherein the displaying scene pictures of the second display object corresponding to different observation manners on the real-scene interaction interface comprises:
displaying a number of online visitors of the second display object on the real-scene interaction interface; and
in response to a visit operation of a second user account on the second display object, increasing the number of online visitors on the real-scene interaction interface of the first user account.

8. The method according to claim 1, wherein the displaying a real-scene interaction interface of a second display object associated with the first display object comprises:
in response to a statement component of the information flow advertisement receiving a trigger operation, displaying the real-scene interaction interface of the second display object associated with the first display object; wherein the statement component is configured to provide a function for a user account to interact with the information flow advertisement.

9. A computer device comprising a processor and a memory, the memory storing a computer program, and the computer program being loaded and executed by the processor and causing the computer device to implement an information flow advertisement-based interaction method including:
displaying an information flow interface of a first user account, the information flow interface comprising social content transmitted by at least one content publishing account;
displaying, on the information flow interface, an information flow advertisement comprising a first display object;
in response to receiving a first interaction operation on the first display object, displaying a real-scene interaction interface of a second display object associated with the first display object, wherein the second display object represents a physical building; and
in response to receiving a second interaction operation on the second display object, displaying scene pictures of the second display object corresponding to different observation manners on the real-scene interaction interface, the scene pictures comprising recommended objects located in the physical building.

10. The computer device according to claim 9, wherein the displaying scene pictures of the second display object corresponding to different observation manners on the real-scene interaction interface, the scene pictures comprising recommended objects located in the physical building comprises at least one of:
rotating the scene pictures of the second display object;
rotating the recommended objects in the scene pictures of the second display object;
zooming display sizes of the scene pictures of the second display object;
changing a perspective for observing the second display object for simulating a scene in which a user is immersed in observing the second display object; and
changing a position for observing the second display object for simulating a scene in which the user is immersed in observing the second display object.

11. The computer device according to claim 9, wherein the displaying scene pictures of the second display object corresponding to different observation manners on the real-scene interaction interface comprises:
displaying, on the real-scene interaction interface, icons of the recommended objects in the scene pictures of the second display object; and
displaying, in response to the icon of one of the recommended objects receiving a trigger operation, related information of the recommended object.

12. The computer device according to claim 9, wherein the displaying scene pictures of the second display object corresponding to different observation manners on the real-scene interaction interface comprises:
displaying a broadcast icon on the real-scene interaction interface; and
playing an audio file associated with the broadcast icon in response to the broadcast icon receiving a trigger operation.

13. The computer device according to claim 9, wherein the displaying scene pictures of the second display object corresponding to different observation manners on the real-scene interaction interface comprises:
displaying an employee icon on the real-scene interaction interface; and
in response to the employee icon receiving a trigger operation, sending an inquiry to an employee in the physical building corresponding to the employee icon.

14. The computer device according to claim 9, wherein the displaying scene pictures of the second display object corresponding to different observation manners on the real-scene interaction interface comprises:
displaying, on the real-scene interaction interface, a thumbnail map associated with the second display object;
in response to a functional region on the thumbnail map receiving a trigger operation, gradually moving a position of the second display object currently observed to the functional region; and
displaying a scene picture of the second display object observed during the moving.

15. The computer device according to claim 9, wherein the displaying scene pictures of the second display object corresponding to different observation manners on the real-scene interaction interface comprises:
displaying a number of online visitors of the second display object on the real-scene interaction interface; and
in response to a visit operation of a second user account on the second display object, increasing the number of online visitors on the real-scene interaction interface of the first user account.

16. The computer device according to claim 9, wherein the displaying a real-scene interaction interface of a second display object associated with the first display object comprises:
in response to a statement component of the information flow advertisement receiving a trigger operation, displaying the real-scene interaction interface of the second display object associated with the first display object; wherein the statement component is configured to provide a function for a user account to interact with the information flow advertisement.

17. A non-transitory computer-readable storage medium storing a computer program, the computer program being loaded and executed by a processor of a computer device and causing the computer device to implement an information flow advertisement-based interaction method including:
displaying an information flow interface of a first user account, the information flow interface comprising social content transmitted by at least one content publishing account;
displaying, on the information flow interface, an information flow advertisement comprising a first display object;
in response to receiving a first interaction operation on the first display object, displaying a real-scene interaction interface of a second display object associated with the first display object, wherein the second display object represents a physical building; and
in response to receiving a second interaction operation on the second display object, displaying scene pictures of the second display object corresponding to different observation manners on the real-scene interaction interface, the scene pictures comprising recommended objects located in the physical building.

18. The non-transitory computer-readable storage medium according to claim 17, wherein the displaying scene pictures of the second display object corresponding to different observation manners on the real-scene interaction interface, the scene pictures comprising recommended objects located in the physical building comprises at least one of:
rotating the scene pictures of the second display object;
rotating the recommended objects in the scene pictures of the second display object;
zooming display sizes of the scene pictures of the second display object;
changing a perspective for observing the second display object for simulating a scene in which a user is immersed in observing the second display object; and
changing a position for observing the second display object for simulating a scene in which the user is immersed in observing the second display object.

19. The non-transitory computer-readable storage medium according to claim 17, wherein the displaying scene pictures of the second display object corresponding to different observation manners on the real-scene interaction interface comprises:
displaying a broadcast icon on the real-scene interaction interface; and
playing an audio file associated with the broadcast icon in response to the broadcast icon receiving a trigger operation.

20. The non-transitory computer-readable storage medium according to claim 17, wherein the displaying scene pictures of the second display object corresponding to different observation manners on the real-scene interaction interface comprises:
displaying an employee icon on the real-scene interaction interface; and
in response to the employee icon receiving a trigger operation, sending an inquiry to an employee in the physical building corresponding to the employee icon.
